(19) United States
(12) Patent Application Publication
(10) Pub. No.: US 2014/0062054 A1
(43) Pub. Date: Mar. 6, 2014

(54) Tire Rim, Wheel, Rolling Apparatus, and Tire

(71) Applicant: Martijn Schaaper, Monster (NL)

(72) Inventor: Martijn Schaaper, Monster (NL)

(73) Assignee: BOBERGO B.V., Den Haag (NL)

(21) Appl. No.: 13/598,002

(22) Filed: Aug. 29, 2012

(51) Int. Cl. B60B 21/02; B60B 37/10; A61G 5/10; B60B 1/00; B60C 15/02

(52) U.S. Cl. CPC B60B 21/023; B60B 1/006; B60C 15/0236; A61G 5/10; B60B 37/10
USPC 280/250.1; 301/95.101; 152/539; 152/450; 280/80.1

(57) ABSTRACT

A tire rim for a rolling apparatus with wheels mounted with a camber. The rim comprises a first shoulder having a first diameter, a second shoulder having a second diameter, and a main body arranged for connecting spoke elements, wherein the first diameter is larger than the second diameter. By having the first diameter of the first shoulder larger than the second diameter of the second shoulder the restrains of the tire at the first shoulder will be different than the restrains of the tire at the second shoulder. By mounting a wheel, comprising the tire rim according to the invention, with a camber, wherein the first and second shoulder have a substantially similar distance to the floor, the tire may be supported substantially more opposite to the floor.

This invention relates to a tire rim for use in spoked wheels, which are mounted to wheelchairs or tricycles with a camber.

Spoked wheels mounted with a camber to a rolling apparatus, such as a wheelchair or a tricycle, are known. For the use in sports such as for example wheelchair basketball, wheelchair rugby and/or wheelchair tennis, the wheelchair is propelled by the seated occupant turning the rear wheels by hand and the rear wheels are mounted at an angle between 3 and 25 degrees with normal. The camber enhances the stability, improves the pivot speed and protects the hands during collision with another wheelchair.

Spoked wheels, with a size also used for bicycles, are preferred by wheelchair athletes, because these wheels are light and relatively strong compared to solid wheels made of carbon composite. Spoked wheels can resist high impact, especially when athletes use a so called “boxing technique” to move forward. Besides, the rim of a spoked wheel normally has relatively high shoulders compared to the relatively low shoulders of common tubular rims of carbon wheels. Also, such a rim may include retaining ridges at the free ends of the shoulders. The relatively high shoulders and the retaining ridges at the free ends of the shoulders can make a spoked wheel particularly suitable for use with occasional lateral forces on the wheel, which for instance occur during skidding or when performing a bouncing technique such as a “boxing technique”.

It is an object of the invention to provide a tire rim for spoked wheels that improves the performance of the wheels when mounted to a human powered rolling apparatus with a camber.

It was observed that self-propelled wheelchairs with wheels mounted with a negative camber have higher rolling friction than wheelchairs with wheels mounted perpendicular to the floor. The asymmetrical force on the tire of the wheel in the inclined position results in particular side-way deformation of the tire and consequently extra loss of energy.

When a regular wheel, comprising a regular symmetrical tire rim with a first shoulder and a second shoulder supporting a regular symmetrical tire with a first side wall and a second side wall, is mounted perpendicular to the floor, the tire is supported opposite to the floor. The position of the support area between the two shoulders of the tire rim is in the middle above the contact patch, i.e. the area of the tread of the tire during use actually being in contact with the floor. Furthermore, both shoulders of the tire rim have the same distance to the floor and the first shoulder supports the first side wall of the tire the same as the second shoulder supports the second side wall of the tire.

When this regular wheel is mounted with a camber the tire rim is not supporting the tire as opposite to the floor as when the regular wheel is mounted perpendicular to the floor. The support area between the two shoulders of the tire rim has been dislocated and rotated by turning the regular wheel to the inclined position of the camber. The dislocated position of the support area between the two shoulders of the tire rim is not anymore in the middle above the contact patch. Furthermore, the rotated position of the support area, with the first shoulder having a larger distance to the floor than the second shoulder, provides a different support of the first shoulder for the first side wall than of the second shoulder for the second side wall. The restrains of the first shoulder are too little, providing for the first side wall of the tire to deform outward and the restrains of the second shoulder are too strong, providing for the second side wall of the tire to prevent deformation outward. The particular restrains on the tire by the tire rim and the asymmetrical force at the contact patch provide for a support not opposite to the floor and for particular side-way deformation of the tire.

Thereto, the invention provides a tire rim for a rolling apparatus with wheels mounted with a camber, the rim comprising a first shoulder having a first diameter, a second shoulder having a second diameter, and a main body arranged for connecting spoke elements, wherein the first diameter is larger than the second diameter.

By having the first diameter of the first shoulder larger than the second diameter of the second shoulder the restrains of the tire at the first shoulder will be different than the restrains of the tire at the second shoulder. By mounting a wheel, comprising the tire rim according to the invention, with a camber, wherein the first and second shoulder have a substantially similar distance to the floor, the position of the support area between the first shoulder and the second shoulder is substantially in the middle above the contact patch. Furthermore, the restrains of the first shoulder and the second shoulder on the tire are balanced to provide for less side-way deformation. Therefore, the tire is opposite to the floor substantially more evenly supported by the tire rim.

It is noted that a rolling apparatus with wheels mounted with a camber may be a human powered rolling apparatus, which may be but not necessarily limited to a manually powered, preferably a manually propelled apparatus. Advantageously, the apparatus can be powered by manually propelling one or more pushrims attached to one or more wheels, preferably rear wheels. Alternatively or additionally, the apparatus, for instance being a handcycle such as a tricycle, may be drivable in other ways, for instance by driving hand cranks or by driving pedal cranks.

Further, it is noted that the apparatus may for instance be a device having at least three wheels. Preferably at least two wheels, more preferably two rear wheels, are spoked wheels. Besides, the apparatus may comprise other wheels, for instance caster wheels such as swivel casters, which may form front wheels of the apparatus. It is noted that, in embodiments, not all wheels of the rolling apparatus need to be, but nevertheless can be, mounted with a camber.

In particular embodiments of the invention the tire rim may have specific dimensions that provide particular advantages for a rolling apparatus with wheels mounted with a camber. Wheels for such rolling apparatus, often being a human powered rolling apparatus, like bicycles, tricycles and wheelchairs, regularly have different dimensions than wheels for a motor powered rolling apparatus, like automobiles and motorcycles. Wheels for a human powered rolling apparatus mostly have a relatively large diameter for a good transmission combined with a relatively narrow tire rim for low weight and low friction. A tire rim, wherein the first and second diameter is between 400 mm and 660 mm and the distance between the first and second shoulder is between 18 mm and 54 mm are most advantageous for wheels for a rolling apparatus with wheels mounted with a camber.

The tire rim can be made from any desired material regularly in use for making tire rims. Particular embodiments of the invention, however, advantageously, may use metal for the tire rim. The material is strong and tough, and ultimately suitable for making arrangements for connecting spoke elements. Furthermore, in particular embodiments of the invention the metal may be aluminum or an aluminum alloy and optionally the rim may be manufactured using extrusion. Each of these details provides particular advantages and can be implemented independently of the other.

The tire rim may be formed as a separate component. This is, the tire rim can be manufactured and supplied as an independent and/or separate part of a spoked wheel, and is not integrally formed with the rest of the wheel. For example, the tire rim and the hub of such a spoked wheel are built up of two different, independent components, which can be connected to each other by means of spokes.

In particular embodiments the tire rim may have an integrated pushrim, which may be advantageous when used in a wheel for a wheelchair, especially in a rear wheel of a hand propelled wheelchair.

The invention also comprises a wheel including an independent tire rim discussed above and laid down in the appended claims. This wheel may comprise a standard tire, for instance a tubular tire or a tubed tire having an outer tire and a separate inner tube.

The invention further comprises a tire specially designed to a tire rim discussed above and laid down in the appended claims.

In particular embodiments of the invention, the tire comprises a first bead, a first side wall, a tread, a second side wall and a second bead, and the length of the first side wall is substantially equal to the length of the second side wall, wherein the first bead has a larger circumferential diameter than the second bead.

Furthermore, in particular embodiments of the invention the tire is a tubular tire comprising constructional elements, such as reinforcements such as a carcass of fabric plies, a gluing strip, a puncture resistant strip and a tread, wherein at least one of these structural elements is asymmetrically positioned over the cross section of the tire. The tubular element may extend in circumferential direction of an air chamber of the tubular tire over the substantially entire circumference of said air chamber. Further, the tubular element may widthwise extent over a part of the substantially circular cross section of a tube of the tubular tire. It is noted that asymmetrically positioned over the cross section may at least mean that said constructional element is widthwise extending from a central plane of the tubular tire further to one side than it is extending to the other side of said central plane, wherein the central plane may extend substantially through the center of the tube of the tire and/or substantially lateral to a central axis or so called center line of the tire. In particular embodiment of the invention the tire advantageously is used in combination with a tire rim according to the invention. The tire may be supported by the tire rim in an advantageous way according to the invention. Furthermore, the tread of the tire will wear in the middle.

The invention further comprises a rolling apparatus with a wheel discussed above and laid down in the appended claims. In particular embodiments of the invention this rolling apparatus may have a wheel with its center line mounted at any angle to the floor other than parallel to the floor. Between three degrees and twenty five degrees have proven to be the most advantageous, however. In particular embodiments of the invention the rolling apparatus is a wheelchair.

The invention further relates to a method of supporting tires of spoked wheels mounted with a camber substantially more opposite to the floor.

Further advantageous embodiments are in the dependent claims.

With reference to the exemplary embodiments shown in the drawings the invention will now be specified, although only by way of example. In the drawings:

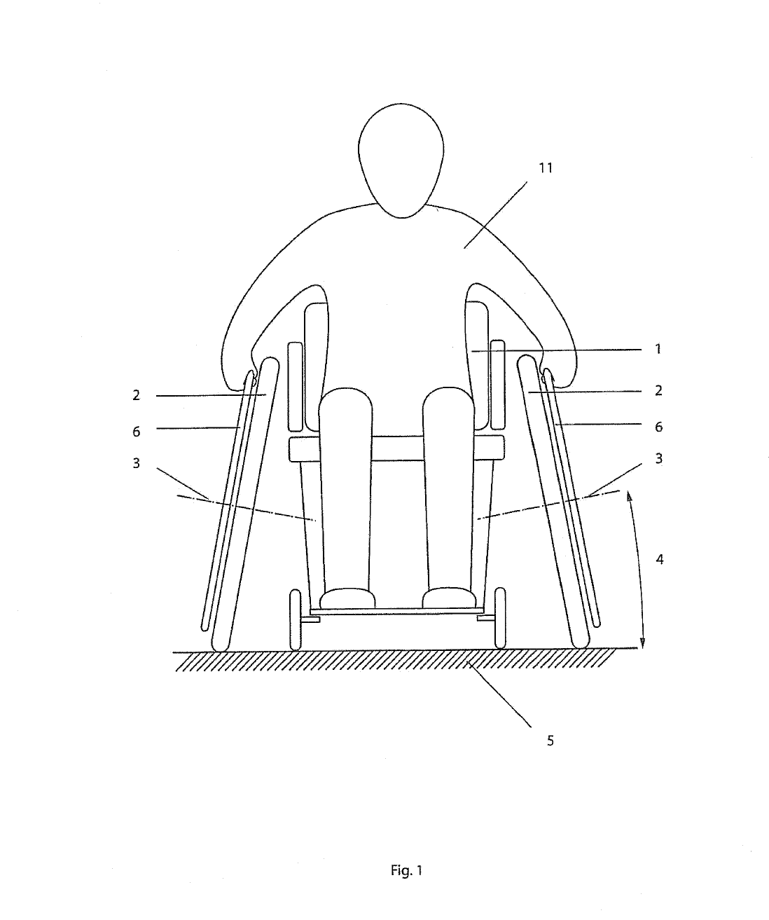

FIG. 1 shows a front view of a wheelchair with wheels with a center line mounted with a camber at an angle to the floor.

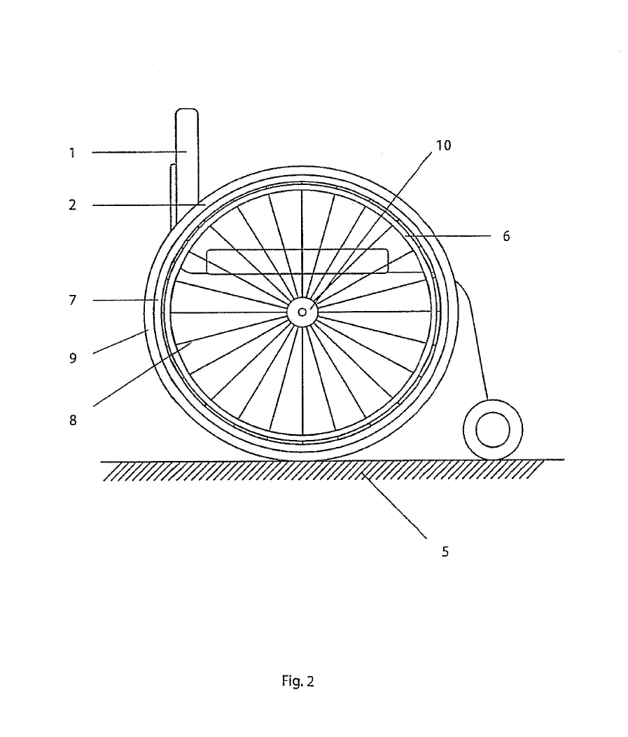

FIG. 2 shows a side view of a wheelchair.

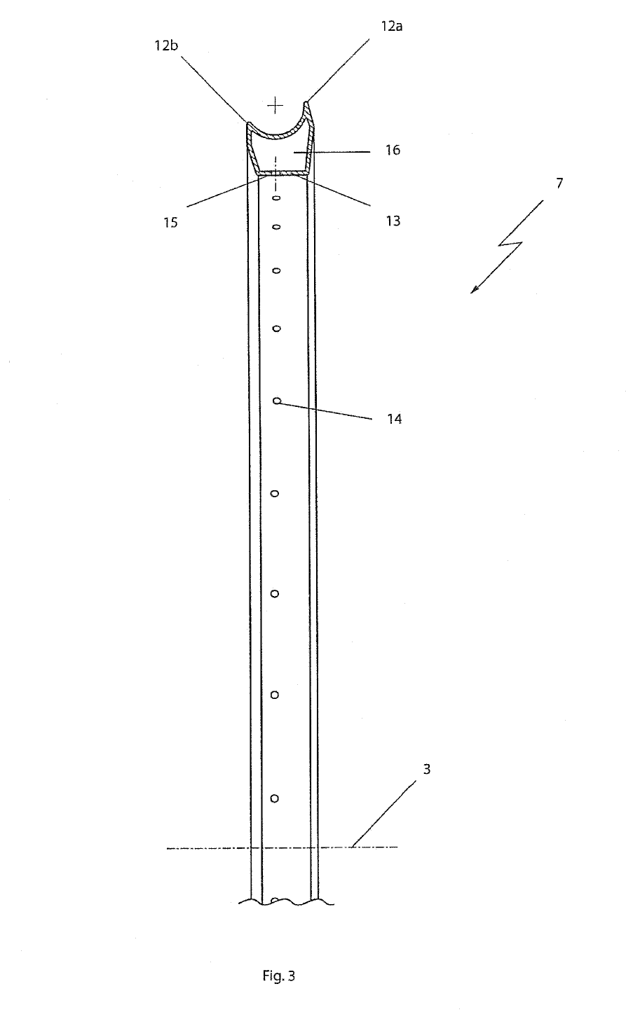

FIG. 3 shows a cross section of a first embodiment of the tire rim according to the invention.

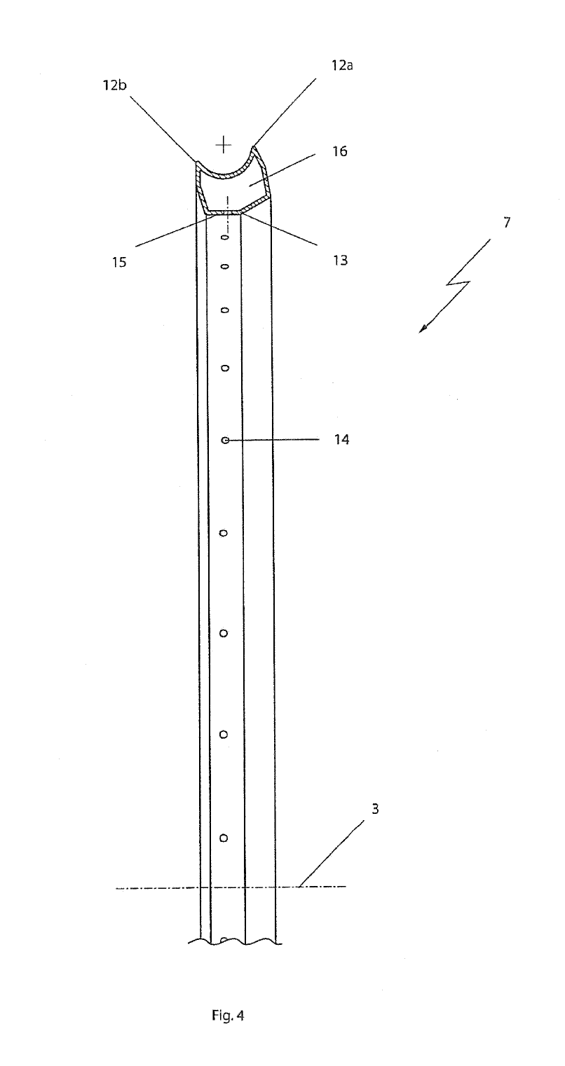

FIG. 4 shows a cross section of a second embodiment of the tire rim according to the invention.

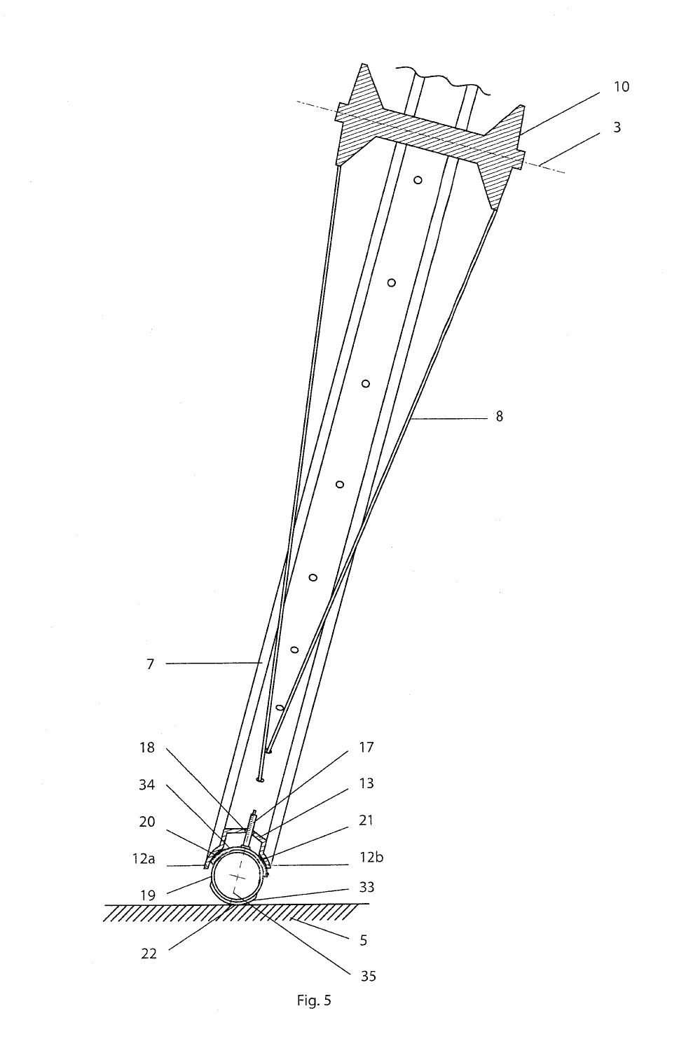

FIG. 5 shows a cross section of an embodiment of a wheel with a tire rim according to the invention.

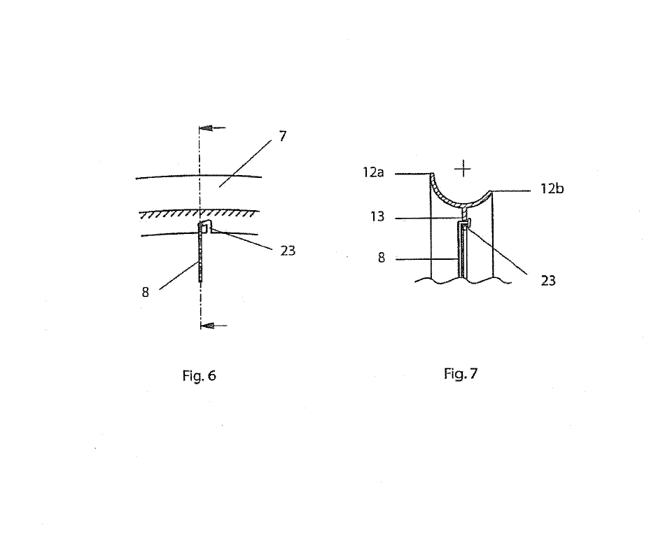

FIG. 6 shows a partial side view of a further embodiment of the tire rim according to the invention with a spoke element.

FIG. 7 shows a cross section of FIG. 6.

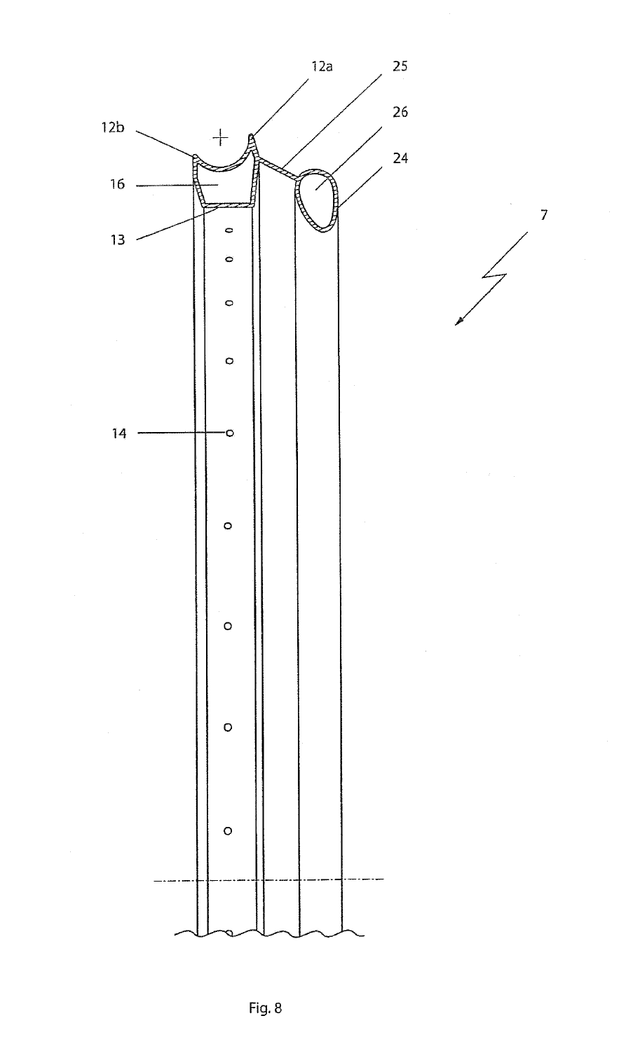

FIG. 8 shows a cross section of an embodiment of the tire rim with integrated pushrim according to the invention.

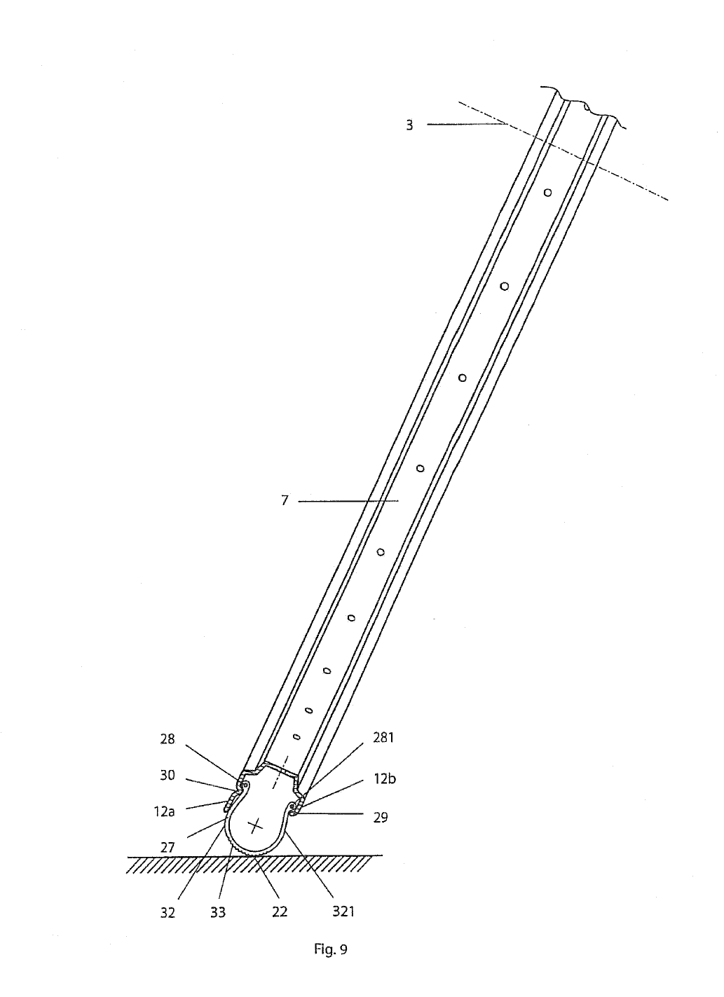

FIG. 9 shows a cross section of a further embodiment of the tire rim according to the invention with a standard tire.

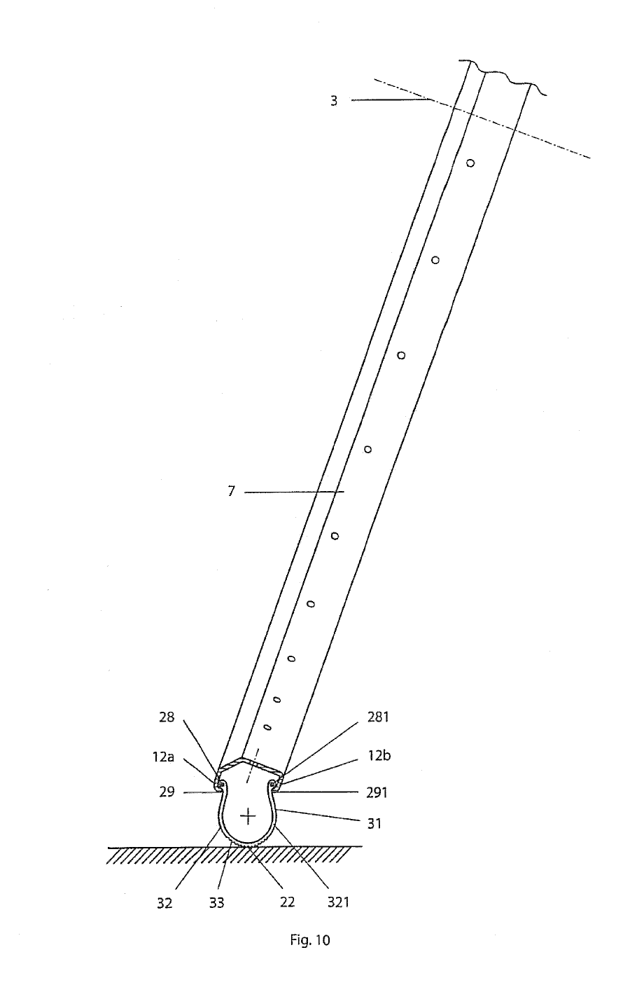

FIG. 10 shows a cross section of a further embodiment of the tire rim according to the invention and an embodiment of a tire according to the invention.

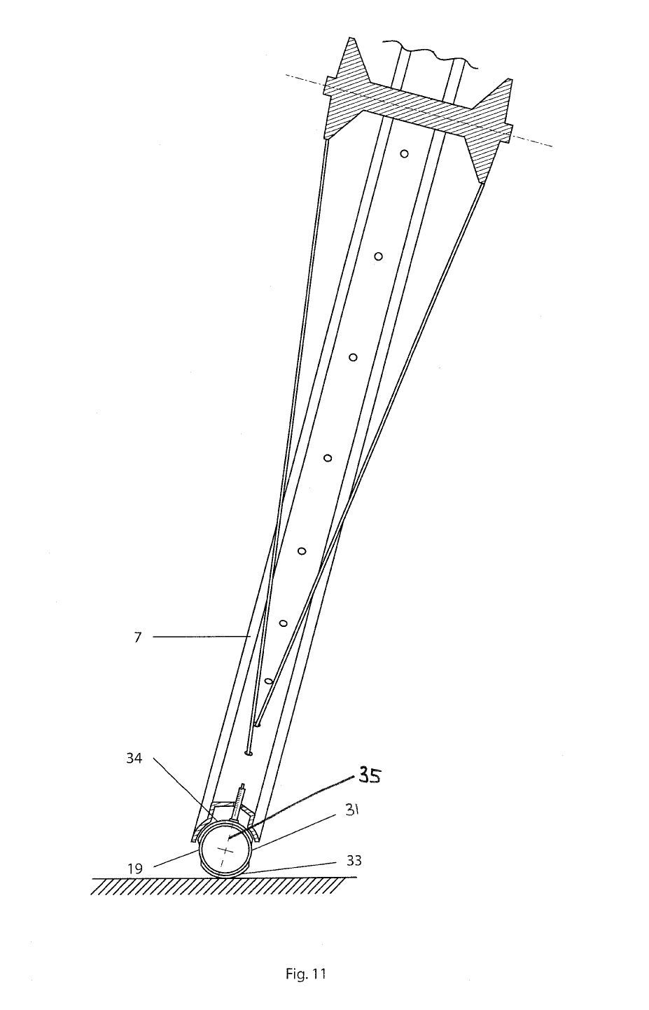

FIG. 11 shows a cross section of an embodiment of a wheel with a tire rim according to the invention and an embodiment of a tire according to the invention.

It is noted that the drawings are only diagrammatic and schematic representations of exemplary embodiments of the invention. The embodiments are given by way of non-limiting examples. In the figures, the same or corresponding parts are represented with the same reference numerals.

FIGS. 1 and 2 show a wheelchair 1 comprising wheels 2 with its center line 3 mounted with a camber at an angle 4 to the floor 5. The wheel 2 comprises a tire rim 7, spoke elements 8, a tire 9 and a hub 10. The spoke elements 8 may be compression spokes or tension spokes. Advantageously tension spokes are used consisting of elongated rigid steel wire elements arranged for connecting to the tire rim 7 and the hub 10. Alternatively, tension spokes may also consist of bendable wire elements or chains.

The wheel 2 further comprises a pushrim 6 to manually propel the wheelchair 1 by the person 11 sitting in the wheelchair 1.

FIG. 3 shows a cross section of a first embodiment of the tire rim according to the invention. The tire rim 7 comprises a first shoulder 12a, a second shoulder 12b and a main body 13 arranged for connecting spoke elements by means of holes 14. In this particular embodiment the tire rim may be aluminum and manufactured by extrusion to first form a hollow, non-symmetrical, aluminum extrusion profile with a cavity 16. Secondly, the extrusion profile may, advantageously, be rolled over reference surface 15 of main body 13 to bend an open ring. Finally, the ring may be closed by using a regular connection technique, like for example welding, gluing or screwing, to obtain a tire rim according to the invention. The first shoulder 12a of the tire rim 7 has a larger circumferential diameter measured than the second shoulder 12b of the tire rim 7.

A second embodiment of the invention is shown in FIG. 4. This particular embodiment comprises a tire rim 7 with a similar hollow extrusion profile with a cavity 16. Alternatively, the extrusion profile of this embodiment of the invention advantageously has a symmetrical cross section. The extrusion profile may be rolled over reference surface 15 of main body 13 to manufacture a tire rim according to the invention. Holes 14 provide for an arrangement to connect spoke elements.

FIG. 5 shows a cross section of an embodiment of a wheel with a tire rim according to the invention. In this example the tire rim 7 comprises shoulders 12a and 12b and a main body 13. In this particular embodiment the tire rim may be shaped of steel strip by means of roll forming Here, support surfaces 20 and 21 are shaped in a particular way to support a standard tubular tire 19, which can be glued to the tire rim 7. Here, the standard tubular tire 19 comprises a tread 33 and a gluing strip 34, the tread 33 and the gluing strip 34 being symmetrically relative to a central plane 35 of the tire 19. Further, a hole 18 provides for a passage for a tire valve 17 of the tubular tire 19.

The wheel is positioned with a camber in such a way that the distance between the first shoulder 12a and the floor 5 is substantially similar to the distance between the second shoulder 12b and the floor 5. The area of the tire rim between the shoulders 12a to 12b may support the tire more equally divided above the contact patch 22 than a conventional wheel mounted with a camber. The contact patch 22 may be substantially in the middle below the area between 12a and 12b and supporting the tire substantially more opposite to the floor.

The standard tubular tire 19 may be twisted during mounting and may be glued in a twisted position in such a way that the gluing strip 34 fits better in the tire rim 7, i.e. a larger part of the gluing strip makes contact with the support surfaces 20, 21 of the rim, and in such way that the contact patch 22 is substantially more in the middle of the tread 33. A disadvantage of using a standard tubular tire in a twisted position is that the mounting is very cumbersome and a lot of force is needed. Furthermore, it is a disadvantage that the valve 17 comes in a twisted position as well.

Standard tubular tires are known with a symmetrically positioned tread where the shape of the tread is asymmetrical with respect to a central plane of the tire. This particular tubular tire still has to be twisted relative to the center of its air chamber for best performance.

FIGS. 6 and 7 show a further embodiment of a tire rim 7 with different sized shoulders 12a and 12b according to the invention which may be titanium and manufactured by extrusion. The illustrations show a non-hollow, non-symmetrical extrusion profile that may be shaped to a tire rim according to the invention. Main body 13 is provided with slots 23 to connect spoke elements 8.

In FIG. 8 is a further embodiment of the invention shown. A tire rim with an integrated pushrim advantageously made in a single extrusion process. The extrusion profile has two hollow bodies 13 and 24 with cavities 16 and 26 connected with a bridging section 25. Main body 13 has unequal shoulders 12a and 12b and arrangements 14 for connecting spoke elements. Body 24 is integrally fixed to main body 13 with bridging section 25. Body 24 provides for an ergonomically shaped pushrim that is an integral part of tire rim 7.

FIG. 9 depicts another embodiment of the tire rim 7 according to the invention. The tire rim 7 provides for shoulders 12a and 12b. The tire rim is designed to support a standard tire 27 with steel or Kevlar reinforced beads 28 and 281, side walls 32 and 321 and tread 33. The tread may be a distinct rough area with grooves or a nondescript smooth and slick area to provide an appropriate level of traction that does not wear away too quickly. The standard tire may be hold in place by a support 29 on shoulder 12b and a support 30 on shoulder 12a. The supports 29, 30 may be formed as retaining ridges 29, 30. Because the circumferential diameter of the beads 28 and 281 of the standard tire 27 are equal, the distance between support 29 and center line 3 is substantially equal to the distance between support 30 and center line 3. Support 29 may be the end of shoulder 12b and shoulder 12a may be extended beyond support 30 to provide a support of the tire more equally divided above the contact patch 22. When using a standard tire 27 with side wall 28 equal to side wall 281 the contact patch 22 will not be in the middle of tread 33.

Therefore, the invention further provides for a tire, for instance a tubeless tire or an outer tire for accommodating an inner tube, having two beads having a substantially equal circumferential diameter, two side walls extending from the respective bead to the tread, wherein a first of the two side walls is higher than a second one. Such a tire may for instance be mounted to the rim shown in FIG. 9. Preferably, the tire is mounted to a cambered or skewed wheel in such a way that the wider one of the side wall is positioned at an upward facing side of the wheel, whereas the less wide side wall of the tire is positioned at a downward facing side of said wheel.

FIG. 10 depicts an alternative embodiment of tire rim 7 according to the invention and an embodiment of a tire 31 according to the invention. The tire rim 7 comprises of a center line 3, shoulders 12a and 12b, supports 29 and 291. Alternative to the previous embodiment, the distance between support 29 and center line 3 is different from the distance between support 291 and center line 3. In this particular embodiment according to the invention, the support 29 is the end of shoulder 12a and the support 291 is the end of shoulder 12b. This embodiment is particularly suitable to be mounted with a tire 31 according to the invention.

Tire 31 comprising a first bead 28, a first side wall 32, a tread 33, a second side wall 321 and a second bead 281. The width of the first side wall 32 is substantially equal to the width of the second side wall 321, wherein the first bead 28 has a larger circumferential diameter than the second bead 281. However, in embodiments, two side walls can have different widths. For instance, a side wall 32 extending from the bead having the larger diameter may have a wider side wall than the second side wall 321.

In accordance with an advantageous feature of the invention and as can be seen in FIG. 10, tire 31 illustratively may be mounted to tire rim 7 in a way that bead 28 is supported by support 29 and bead 281 is supported by support 291. A wheel comprising a tire 31 and tire rim 7 mounted with a camber as illustrated may have a contact patch 22 significantly more in the middle of tread 33, while the tire rim may provide support substantially equally divided above contact patch 22.

FIG. 11 shows a cross section of an embodiment of a wheel with a tire rim 7 like in FIG. 5 with a further embodiment of a tire 31 according to the invention. Alternative to the standard tubular tire 19 shown in FIG. 5, the tire 31 shown in FIG. 11 is a tubular tire 31 with structural elements of a gluing strip 34 and a tread 33 advantageously positioned in an asymmetrical way on either side of the central plane 35 of the tire. In this way the tubular tire is optimally designed for use with the tire rim according to the invention. The tubular tire 31 according to the invention will fit the tire rim 7 naturally during mounting without substantially twisting of the tubular tire. Since the tubular tire is not substantially twisted, the tubular tire 31 does not tend to twist back to an initial orientation as does a conventional tubular tire glued into a rim in a twisted orientation.

Many variants will be clear to the person skilled in the art. For example, although the illustrated embodiments of the tire rim have cross sections of equal wall thickness, it may be possible to have variable wall thickness for optimal design. Also, arrangements for connecting spoke elements may be screw joints or hooks. All variants are understood to fall within the scope of the invention as set forth in the appended claims.

1. A tire rim for a rolling apparatus with wheels mounted with a camber comprising a first shoulder having a first diameter, a second shoulder having a second diameter, and a main body arranged for connecting spoke elements, wherein the first diameter is larger than the second diameter.

2. The tire rim according to claim 1, wherein the first and second diameter are between 400 mm and 660 mm and the distance between the first and second shoulder is between 18 mm and 54 mm.

3. The tire rim according to claim 1, wherein the free ends of the shoulders of the rim are provided with retaining ridges.

4. The tire rim according to claim 1, wherein the tire rim is made of metal.

5. The tire rim according to claim 1, wherein the tire rim is made of aluminum.

6. The tire rim according claim 1, wherein the tire rim is made by extrusion

7. The tire rim according to claim 1, wherein the tire rim has an integrated pushrim.

8. A wheel having a center line comprising a tire rim in accordance with claim 1.

9. The wheel according to claim 8, wherein the wheel has a tubular tire.

10. A rolling apparatus having a wheel in accordance with claim 8.

11. The rolling apparatus according to claim 10, wherein at least one wheel according to claim 8 is mounted with the center line at an angle to the floor.

12. The rolling apparatus according to claim 11, wherein the angle is between 3 and 25 degrees.

13. The rolling apparatus according to claim 10, wherein the rolling apparatus is a wheelchair.

14. A tire comprising a first bead, a first side wall, a tread, a second side wall and a second bead, and the width of the first side wall is substantially equal to the width of the second side wall, wherein the first bead has a larger circumferential diameter than the second bead.

15. A tubular tire comprising more than one constructional element of a carcass of fabric plies, a gluing strip, a puncture resistant strip and a tread, wherein at least one of the more than one of the structural elements is positioned asymmetrically.

16. The tubular tire according to claim 15, comprising an asymmetrically positioned valve.

17. A method of supporting tires of spoked wheels mounted with a camber substantially more opposite to the floor.

18. The method according to claim 17, wherein the wheels are mounted to a human powered rolling apparatus.
